(19) United States
(12) Patent Application Publication
(10) Pub. No.: US 2019/0164178 A1
(43) Pub. Date: May 30, 2019

(54) Method and Device for Data Acquisition of Shoes and Computer Storage Media

(71) Applicant: Shenzhen Malong Technologies Co., Ltd., Shenzhen (CN)

(72) Inventors: Matthew Robert Scott, Shenzhen (CN); Dinglong Huang, Shenzhen (CN); Kai Fu, Shenzhen (CN)

(21) Appl. No.: 15/985,400

(22) Filed: May 21, 2018

(30) Foreign Application Priority Data
Nov. 27, 2017 (CN) 201711204107.8

(51) Int. Cl. G06Q 30/02; G06K 9/00

(52) U.S. Cl. CPC G06Q 30/0201; G06Q 30/0205; G06K 9/00671

(57) ABSTRACT

Provided are a method and a device for shoe data acquisition, applied to a shopping mall with a camera provided in a preset area such that only a shoe display area can be photographed and having a photographing region lower than a preset height. The method includes monitoring the shoe display area by the camera to acquire monitoring data containing shoe pictures and movement tracks; recognizing the shoe pictures to determine shoe information and determining time length information corresponding to the movement tracks in the monitoring data; associating the shoe information with the time length information and then storing the shoe information. Thus, by detecting the data moved due to customers' viewing or trying-on of shoes and automatically associating it with the shoes, an automatic shoe data acquisition is achieved, and follow-up data intercommunication can be automatically realized, acquiring more comprehensive data and ensuring the value of the data acquired.

### TECHNICAL FIELD

The present disclosure relates to the field of data processing, and in particular, to a method and a device for data acquisition of shoes and computer storage media.

### BACKGROUND ART

At present, the mode of data acquisition of shoes, especially the sales data, is manually carried out, in which the sales data of various shoes in each store needs to be counted and summed up, this mode however is firstly inefficient due to the manually operation, also secondly is unable to acquire comprehensive data due to data intercommunication between individual businesses or shops, which in turn leads to incomplete data, affecting the value of the data.

### SUMMARY

Aiming to the defects in the prior art, the present disclosure provides a method and a device for data acquisition of shoes and computer storage media, wherein automatic acquisition of data of the shoes is achieved by detecting the data moved due to customers' viewing or trying on of shoes, and automatically associating the data with shoes, and follow-up data intercommunication can be automatically achieved, acquiring more comprehensive data, thus ensuring the value of the data acquired.

Specifically, the present disclosure provides the following specific embodiments:

Embodiments of the present disclosure provides a method for data acquisition of shoes, which is applied to a shopping mall provided with a camera, wherein the camera is provided in a preset area such that only a shoe display area can be photographed, and the camera has a photographing region lower than a preset height; the method includes:

monitoring the shoe display area by the camera, to acquire monitoring data containing shoe pictures and movement tracks of the shoes;

recognizing the shoe pictures in the monitoring data, to determine shoe information; and determining time length information corresponding to the movement tracks in the monitoring data; and

associating the shoe information with the time length information, and then storing the shoe information.

In a specific embodiment, the method also includes:

regularly uploading the shoe information associated with the time length information to a cloud server.

In a specific embodiment, the method also includes:

associating preset information related to the shoes with the time length information as well as the shoe information, and then storing the preset information related to the shoes.

In a specific embodiment, the preset information includes one of the followings: selling time period information of the shoes, shopping mall information, and temperature information of a selling location of the shoes, or any combination of more than one of them.

In a specific embodiment, the method also includes:

regularly summarizing the stored shoe information associated with the time length information; and

determining, based on individual pieces of the shoe information, a total length of time corresponding to time length information which is associated with the shoe information.

Embodiments of the present disclosure provides a device for data acquisition of shoes, which is applied to a shopping mall provided with a camera, wherein the camera is provided in a preset area such that only a shoe display area can be photographed, and the camera has a photographing region lower than a preset height; the device includes:

an acquisition module, configured for monitoring the shoe display area by the camera to acquire monitoring data containing shoe pictures and movement tracks of the shoes;

a confirmation module, configured for recognizing the shoe pictures in the monitoring data, to determine shoe information, and determining time length information corresponding to the movement tracks in the monitoring data;

a processing module, configured for associating the shoe information with the time length information and then storing the shoe information.

In a specific embodiment, the device also includes:

an uploading module, configured for regularly uploading the shoe information associated with the time length information to a cloud server.

In a specific embodiment, the processing module is also configured for:

associating preset information related to the shoes with the time length information and the shoe information and then storing the preset information related to the shoes.

In a specific embodiment, the preset information includes one of the followings: selling time period information of the shoes, shopping mall information, and temperature information of a selling location of the shoes, or any combination of more than one of them.

In a specific embodiment, the device also includes:

an analysis module, configured for regularly summarizing the stored shoe information associated with the time length information;

determining, based on individual pieces of the shoe information, a total length of time corresponding to time length information which is associated with the shoe information.

In view of this, the embodiments of the present disclosure provide a method and a device for data acquisition of shoes, which are applied to a shopping mall provided with a camera, wherein the camera is provided in a preset area such that only a shoe display area can be photographed, and the camera has a photographing region lower than a preset height. The method includes: monitoring the shoe display area by the camera to acquire monitoring data containing shoe pictures and movement tracks of shoes; recognizing the shoe pictures in the monitoring data, to determine shoe information; and determining time length information corresponding to the movement tracks in the monitoring data; associating the shoe information with the time length information and then storing the shoe information. Thus, by detecting the data moved due to customers' viewing or trying on of shoes and automatically associating the data with the shoes, an automatic acquisition of shoe data is achieved, and follow-up data intercommunication can be automatically achieved, acquiring more comprehensive data, thus ensuring the value of the data acquired.

### BRIEF DESCRIPTION OF DRAWINGS

To describe the technical solutions in the embodiments of the present disclosure more clearly, the accompanying drawings required for describing the embodiments are briefly introduced below. It should be understood that the following accompanying drawings show only some embodiments of the present disclosure and thus should not be construed as limiting the scope of the present disclosure, those skilled in the art may also, without any creative efforts, obtain other related drawings based on the drawings.

FIG. 1 is a schematic flow chart of a method for data acquisition of shoes according to an embodiment of the present disclosure;

FIG. 2 is a schematic structure chart of a device for data acquisition of shoes according to an embodiment of the present disclosure;

FIG. 3 is a schematic structure chart of a device for data acquisition of shoes according to an embodiment of the present disclosure;

FIG. 4 is a schematic structure chart of a device for data acquisition of shoes according to an embodiment of the present disclosure;

### DETAILED DESCRIPTION OF EMBODIMENTS

In the following, various embodiments of the present disclosure will be described more comprehensively. The disclosure may have various embodiments, and modifications and variations may be made thereto. It should be understood, however, that there is no intent to limit the various embodiments of the disclosure to the particular embodiments disclosed herein, but that the disclosure should be understood to cover all modifications, equivalents, and alternatives falling within the spirit and scope of the various embodiments of the disclosure.

In the following, the terms “include” or “may include” that may be used in various embodiments of the present disclosure indicate the existence of the disclosed functionality, operation or element and do not limit the increase in one or more functionalities, operations or elements. In addition, as used in various embodiments of the present disclosure, the terms “include”, “have” and their cognates are only intended to mean that a particular feature, number, step, operation, element, component, or combination of the foregoing, and should not be understood to firstly exclude the possibility of presence or increase of one or more other features, numbers, steps, operations, elements, components, or combinations of the foregoing.

In various embodiments of the present disclosure, the expression “or” or “at least one of A or/and B” includes any or all combinations of the words that are listed concurrently. For example, the expression “A or B” or “at least one of A or/and B” may include A, may include B, or may include both A and B.

The expressions (such as “first”, “second”, etc.) used in various embodiments of the present disclosure may modify various constituent elements in various embodiments, but the respective constituent elements may not be limited. For example, the above statements do not limit the order and/or importance of the elements. The above statements are only for the purpose of distinguishing one element from other elements. For example, a first user device and a second user device indicate different user devices, although both are user devices. For example, a first element could be termed a second element, and likewise a second element could also be termed a first element, without departing from the scope of the various embodiments of the present disclosure.

It should be noted: if it is described that one constituent element is “connected” to another constituent element, the first constituent element may be directly connected to the second constituent element, and a third constituent element may be “connected” between the first constituent element and the second constituent element. In contrast, when one constituent element is “directly connected” to another constituent element, it may be understood that no third constituent element exists between the first constituent element and the second constituent element.

The term “user” used in various embodiments of the present disclosure may indicate a person who uses the electronic device or a device (for example, artificial intelligence electronic device) that uses the electronic device.

The terms used in the various embodiments of the present disclosure are merely for the purpose of describing particular embodiments and are not intended to limit various embodiments of the present disclosure. As used herein, the singular forms are intended to include the plural forms as well, unless the context clearly indicates otherwise. Unless otherwise defined, all terms (including technical terms and scientific terms) used herein have the same meaning as commonly understood by one of ordinary skill in the art to which the various embodiments of the present disclosure belong. The terms (such as terms defined in commonly used dictionaries) are to be interpreted as having the same meaning as in the context of the relevant art and shall not be interpreted as having an idealized or overly formal meaning unless clearly limited in the various embodiments of the disclosure.

### Embodiment 1

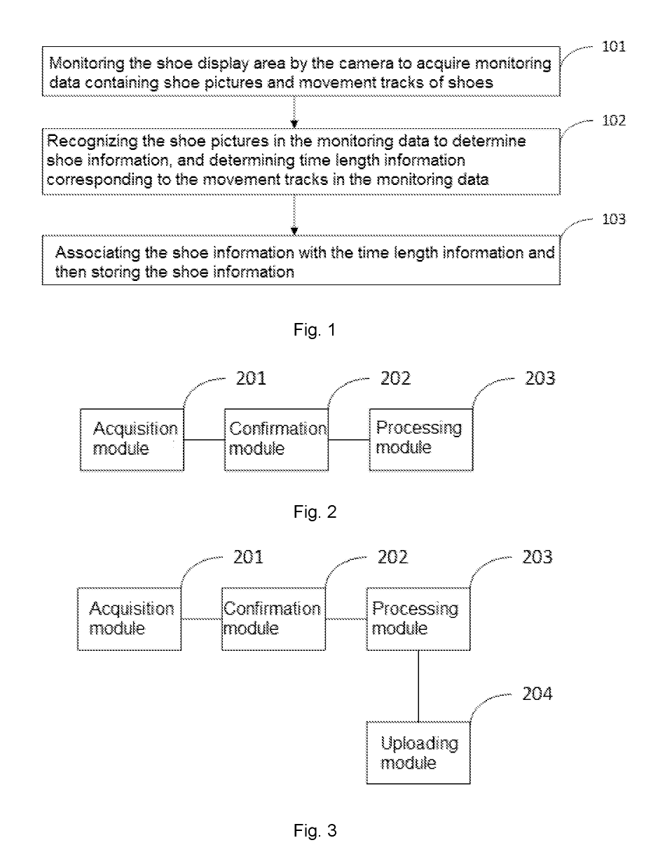

Embodiment 1 of present disclosure discloses a method for data acquisition of shoes, which is applied to a shopping mall provided with a camera, wherein the camera is provided in a preset area such that only a shoe display area can be photographed, and the camera has a photographing region lower than a preset height; and as shown in FIG. 1, the method includes the following steps:

Step 101, monitoring the shoe display area by the camera, to acquire monitoring data containing shoe pictures and movement tracks of the shoes;

specifically, in consideration of the use experience of a user, the camera may be set to be hidden, for example, may be provided in a mirror generally present in a shopping mall, and in consideration of avoiding infringement on the privacy of the user, the camera is provided to be able to photograph only shoe display areas, and the height of the photographing region is lower than a preset height, specifically, the height of the shoes may be used as the limit value so as to ensure that only the shoes can be photographed, and as for the privacy of the user, for example, the privacy-related area such as the face of the user is not photographed.

The specific camera may always monitor the shoe display area, or may carry out monitoring when triggered, specifically, for example, only when the mall is opening, operations needed by customers of buying shoes and trying on shoes or moving shoes and the like, occurs, and thus the camera's shooting time may be limited based on business hours.

In a more specific embodiment, an action trigger may also be provided, and the camera is started to perform monitoring, only when the action trigger detects the movement of the shoes.

Specific monitoring can by implemented by taking pictures of moving shoes to acquire pictures of the shoes and also acquire movement tracks, as well as for example, the movement distance, the length of time of moving and so on, of the moved shoes.

Step 102, recognizing the shoe pictures in the monitoring data, to determine shoe information, and determining time length information corresponding to the movement tracks in the monitoring data;

Specifically, the shoe pictures are subjected to recognizing, which can be performed by matching with a preset photo gallery including all shoe pictures in the shopping mall, and finally determining the information of the shoes, wherein specific information may include shoes' style, color, model, manufacturer and so on.

It is predicted that the length of time corresponding to the movement track may also be acquired simultaneously, the length of time being for example, 1 second, 10 seconds, 24 seconds, etc.

Specifically, in consideration of the validity of the data, a time threshold may be provided, and only time length information in which the time length is longer than the time threshold is retained, and following steps are performed.

Step 103, associating the shoe information with the time length information, and then storing the shoe information.

Specifically, the acquired shoe information is associated with the time length information and then stored, and subsequently exists as data of the shoes. Then after summarization of the data in a certain period of time, analysis may be performed based on the data, so as to for example, obtain information regarding the styles, colors and the like of bestselling shoes by analysis.

In a specific embodiment, the method also includes:

regularly uploading the shoe information associated with the time length information to a cloud server.

Specifically, in another embodiment, the shoe information associated with the time length information may also be regularly uploaded to the cloud server, and subsequently the uploaded data may be summarized by the cloud server and analyzed, so as to obtain more comprehensive data, and further achieve more accurate analysis.

In a specific embodiment, the method also includes:

associating preset information related to the shoes with the time length information and the shoe information and then storing the preset information related to the shoes.

Specifically, in addition to being associated with the time length information, it is also possible to be associated with other preset information as long as it relates to the shoes specifically.

In a specific embodiment, the preset information includes one of the followings: selling time period information of the shoes, shopping mall information, and temperature information of a selling location of the shoes, or any combination of more than one of them.

In a specific embodiment, the method also includes:

regularly summarizing the stored shoe information associated with the time length information; and

determining, based on individual pieces of the shoe information, a total length of time corresponding to time length information which is associated with the shoe information.

Specifically, the stored data may also be preliminarily analyzed. Specifically, the time length information of specific shoes may be summarized, to determine the total length of time of the shoes. Correspondingly, the longer the total length is, the more popular the shoes are, otherwise, the less popular the shoes are.

### Embodiment 2

Embodiment 2 of present disclosure also discloses a device for data acquisition of shoes, which is applied to a shopping mall provided with a camera, wherein the camera is provided in a preset area such that only a shoe display area can be photographed, and the camera has a photographing region lower than a preset height; and as shown in FIG. 2, the device includes:

an acquisition module 201, configured for monitoring the shoe display area by the camera, to acquire monitoring data containing shoe pictures and movement tracks of the shoes;

a confirmation module 202, configured for recognizing the shoe pictures in the monitoring data, to determine shoe information, and determining time length information corresponding to the movement tracks in the monitoring data;

a processing module 203, configured for associating the shoe information with the time length information and then storing the shoe information.

In a specific embodiment, as shown in FIG. 3, the device also includes:

an uploading module 204, configured for regularly uploading the shoe information associated with the time length information to a cloud server.

In a specific embodiment, the processing module 203 is also configured for:

associating preset information related to the shoes with the time length information and the shoe information, and then storing the preset information related to the shoes.

In a specific embodiment, the preset information includes one of the followings: selling time period information of the shoes, shopping mall information, and temperature information of a selling location of the shoes, or any combination of more than one of them.

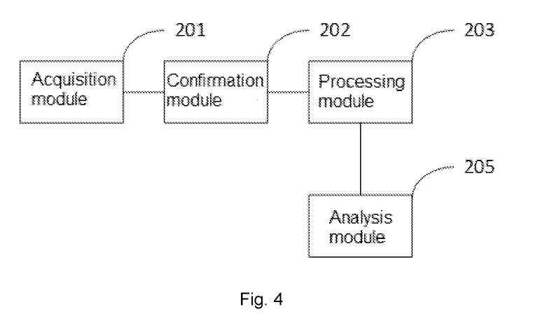

In a specific embodiment, as shown in FIG. 4, the device also includes:

an analysis module 205, configured for regularly summarizing the stored shoe information associated with the time length information; and

determining, based on individual pieces of the shoe information, a total length of time corresponding to time length information which is associated with the shoe information.

In view of this, the embodiments of the present disclosure provide a method and a device for data acquisition of shoes, which are applied to a shopping mall provided with a camera, wherein the camera is provided in a preset area such that only a shoe display area can be photographed, and the camera has a photographing region lower than a preset height; and the method includes: monitoring the shoe display area by the camera, to acquire monitoring data containing shoe pictures and movement tracks of the shoes; recognizing the shoe pictures in the monitoring data, to determine shoe information, and determining time length information corresponding to the movement tracks in the monitoring data; associating the shoe information with the time length information and then storing the shoe information. Thus, by detecting the data moved due to customers' viewing or trying on of shoes, and automatically associating the data with the shoes, an automatic acquisition of shoe data is achieved, and follow-up data intercommunication may be automatically achieved, acquiring more comprehensive data, thus ensuring the value of the data acquired.

A person skilled in the art may understand that the accompanying drawings are merely schematic charts of a preferred embodiment scenario, and the modules or processes in the accompanying drawings are not necessarily required to perform the present disclosure.

A person skilled in the art may understand that modules in a device in an embodiment scenario may be distributed in a device in an embodiment scenario according to an embodiment scenario description, or may also be correspondingly changed, in one or more devices different from that in the embodiment scenario. The above modules of the embodiment scenario may be combined into one module, or may be further split into multiple sub-modules.

The above serial numbers of the present disclosure is merely for the purpose of description and does not represent the pros and cons of the embodiment scenario.

The above are merely several specific embodiment scenarios of the present disclosure. However, the present disclosure is not limited thereto, and any changes that those skilled in the art may think of should fall within the protection scope of the present disclosure.

1. A method for data acquisition of shoes, which is applied to a shopping mall provided with a camera, the camera being provided in a preset area such that only a shoe display area is able to be photographed, and the camera has a photographing region lower than a preset height, wherein the method comprises:
monitoring the shoe display area by the camera to acquire monitoring data containing shoe pictures and movement tracks of the shoes;
recognizing the shoe pictures in the monitoring data to determine shoe information, and determining time length information corresponding to the movement tracks in the monitoring data; and
associating the shoe information with the time length information and then storing the shoe information.

2. The method according to claim 1, further comprising:
regularly uploading the shoe information associated with the time length information to a cloud server.

3. The method according to s claim 1, further comprising:
associating preset information related to the shoes with the time length information and the shoe information, and then storing the preset information related to the shoes.

4. The method according to claim 3, wherein the preset information comprises one of selling time period information of the shoes, shopping mall information, and temperature information of a selling location of the shoes, or any combination of more than one of them.

5. The method according to claim 1, further comprising:
regularly summarizing the stored shoe information associated with the time length information; and
determining, based on individual pieces of the shoe information, a total length of time corresponding to time length information which is associated with the shoe information.

6. A device for data acquisition of shoes, which is applied to a shopping mall provided with a camera, the camera being provided in a preset area such that only a shoe display area is able to be photographed, and the camera having a photographing region lower than a preset height, wherein the device comprises:
an acquisition module, configured for monitoring the shoe display area by the camera, to acquire monitoring data containing shoe pictures and movement tracks of the shoes;
a confirmation module, configured for recognizing the shoe pictures in the monitoring data to determine shoe information, and determining time length information corresponding to the movement tracks in the monitoring data; and
a processing module, configured for associating the shoe information with the time length information and then storing the shoe information.

7. The device according to claim 6, further comprising:
an uploading module, configured for regularly uploading the shoe information associated with the time length information to a cloud server.

8. The device according to claim 6, wherein the processing module is further configured for:
associating preset information related to the shoes with the time length information and the shoe information, and then storing the preset information related to the shoes.

9. The device according to claim 8, wherein the preset information comprises one of selling time period information of the shoes, shopping mall information, and temperature information of a selling location of the shoes any combination of more than one of them.

10. The device according to claim 6, further comprising:
an analysis module, configured for regularly summarizing the stored shoe information associated with the time length information; and determining, based on individual pieces of the shoe information, a total length of time corresponding to time length information which is associated with the shoe information.
